(19) United States
(12) Patent Application Publication
(10) Pub. No.: US 2009/0319292 A1
(43) Pub. Date: Dec. 24, 2009

(54) Method and System to Manage Caregiver Costs in a Health Care Facility

(76) Inventors: Michael Warner, Chapel Hill, NC (US); Kraig McKinley, Cary, NC (US)

Correspondence Address: MOORE & VAN ALLEN PLLC, P.O. BOX 13706, Research Triangle Park, NC, 27709, US

(21) Appl. No.: 12/143,294

(22) Filed: Jun. 20, 2008

(51) Int. Cl. G06Q 50/00; G06Q 10/00

(52) U.S. Cl. 705/2

(57) ABSTRACT

A method to manage caregiver costs in a health care facility may include allowing selection of a patient or group of patients for analyzing care costs and allowing selection of a set of parameters related to services provided to the patient or group of patients by the health care facility. The method may also include collecting patient data associated with the selected patient or group of patients based on the set of parameters. The method may additionally include determining at least one of patient acuity, location within the health care facility and caregiver attributes for the selected patient or group of patients based on the patient data and determining care costs based on at least one of the patient acuity, location, and caregiver attributes for the patient or group of patients. The method may further include presenting a care costs report to a user to manage costs within the health care facility.

### RELATED APPLICATIONS

The present application is related to pending U.S. patent application Ser. No. 11/307,356, filed Feb. 2. 2006, and entitled: “Method and System to Measure Demand for Staff by Clinical Patterns, Predict Future Demand, and Support Optimal Staffing Decisions,” which is assigned to the same assignee as the present application and is incorporated herein in its entirety by reference.

The present application is also related to pending U.S. patent application Ser. No. 11/688,454, filed Mar. 20, 2007, entitled “Method and System to Determine Patient Acuity, Caregiver Intensity, Staffing Needs, and Caregiver Attributes from Patient Outcomes and Patient Events,” which is assigned to the same assignee as the present invention and is incorporated herein in its entirety by reference.

### COPYRIGHT NOTICE

A portion of the disclosure of this patent document contains material that is subject to copyright protection. The copyright owner has no objection to the facsimile reproduction by anyone of the patent document, or the patent disclosure, as it appears in the Patent and Trademark Office patent files or records, but otherwise reserves all copyright rights whatsoever.

### BACKGROUND OF THE INVENTION

The present invention relates to determining the costs of caregivers for individual patients and groups of patients in hospitals and other health care institutions. Caregiver costs may be determined for a single patient or a group of patients for any interval of time from any portion of the patient's stay, as well as on specified locations. Currently caregiver costs are included with “room and board” costs for health care institutions, and treated as essentially fixed costs. This forces the assumption that patient care costs are the same for all patients at the location, whereas the cost of care of patient A may be twice the cost of care of patient B, and indeed the cost of care for patient A during the first three hours of some time period may be twice the cost of care for the same patient during the second three hours of the time period. The need to separate out caregiver care costs in health care is described in an article by Welton; John M Welton, et al., entitled “Nursing Intensity Billing” in The Journal of Nursing Administration, Vol. 16, Number 4, pp 181-188, April 2006.

### BRIEF SUMMARY OF THE INVENTION

In accordance with an embodiment of the present invention, a method to determine at least one of Standard Care Costs, Target Care Costs, Actual Care Costs, Reimbursed Care Costs or the “Total” version of these four for a Patient or Group of Patients over a specified Time Interval may be based on Patient Acuity data, Patient Events data, individual Caregiver costs, average Caregiver costs by Skill or Location, Standard Staffing, Target Staffing, Actual Staffing, Overhead Care Costs (average or by Skill and Location) or other data. The different costs and terms used herein are defined in more detail below. The data may be captured either real time from electronic systems, or from direct manual entry of such data entered by Caregivers or other authorized personnel, or from both electronic systems and direct entry.

In accordance with another embodiment of the present invention, a method to manage caregiver costs in a health care facility may include allowing selection of a patient or group of patients for analyzing care costs and allowing selection of a set of parameters related to services provided to the patient or group of patients by the health care facility. The method may also include collecting patient data associated with the selected patient or group of patients based on the set of parameters. The method may additionally include determining at least one of patient acuity, location within the health care facility and caregiver attributes for the selected patient or group of patients based on the patient data and determining care costs based on at least one of the patient acuity, location, and caregiver attributes for the patient or group of patients. The method may further include presenting a care costs report to a user to manage caregiver costs within the health care facility.

In accordance with another embodiment of the present invention, the method may also include determining an amount and Skill of Caregiver staffing needed (Target Staffing) over a specified Time Interval using the Acuity and Events data and the Acuity Methodology so that the appropriate Caregiver staffing (Target Staffing) is known for each Patient.

In accordance with another embodiment of the present invention, the method may also include determining the number and Skills of Caregiver staffing actually consumed by the Patient or Group of Patients over a specified Time Interval from the staff present on the Location or otherwise caring for the Patient or Patients, individual Patient's Acuity levels and Events, and Caregiver Assignments to Patients so that actual Caregiver consumption is known for each Patient.

In accordance with another embodiment of the present invention, a system to manage caregiver costs in a health care facility may include a processor and a module operable on the processor to determine care costs. The module may include a feature to allow selection of a set of parameters related to services provided to the patient or group of patients by the health care facility and to collect patient data associated with the selected patient or group of patients based on the set of parameters. The module may also determine at least one of patient acuity, location within the health care facility and caregiver attributes for the selected patient or group of patients based on the patient data, and determine care costs based on at least one of the patient acuity, location, and caregiver attributes for the patient or group of patients.

In accordance with another embodiment of the present invention, a computer program product to manage caregiver costs in a health care facility may include a computer usable medium having computer usable program code embodied therein. The computer usable medium may include computer usable program code configured to allow selection of a patient or group of patients for analyzing care costs and computer usable program code configured to allow selection of a set of parameters related to services provided to the patient or group of patients by the health care facility. The computer useable medium may also include computer usable program code configured to collect patient data associated with the selected patient or group of patients based on the set of parameters. The computer useable medium may also include computer usable program code configured to determine at least one of patient acuity, location within the health care facility and caregiver attributes for the selected patient or group of patients based on the patient data and computer usable program code configured to determine care costs based on at least one of the patient acuity, location, and caregiver attributes for the patient or group of patients. The computer useable medium may further include computer usable program code configured to present a care costs report to a user to manage caregiver costs within the health care facility.

The captured acuity, events, staffing, assignment, and other data as needed may include real-time or near real-time data from electronic care documentation systems that may be maintained by an interdisciplinary care team or the like. A health industry information exchange standard known as Health Level Seven (HL7) may be used; however, future information exchange standards may also provide the real-time or near real-time data.

Alternatively, or in addition to patient acuity, events, staffing, assignment, and other data as needed from electronic documentation systems, the captured data may include direct entry of pertinent data that is maintained in physical, paper or hard copy records, or a summarization of such records.

Other aspects and features of the present invention, as defined solely by the claims, will become apparent to those ordinarily Skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method to determine Standard Care Costs, Target Care Costs, Actual Care Costs, and the “Total” version of these three, and to generate reports and compare these costs among themselves and other costs in accordance with an embodiment of the present invention.

FIGS. 2A-2D are collectively an example of a Care Cost Report that may be generated from the process in FIG. 1 in accordance with an embodiment of the present invention.

FIG. 3 is an example of a system to determine all Care Costs defined above based on patient acuity and events data, staffing data, and other data in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As used herein, the following terms may be defined as follows:

“Patient(s)” may be individuals who have entered a health care institution (or are being cared for elsewhere) to attempt to improve their health or physical or mental condition, and who consume resources of the institution, including caregivers (see below). While the example described herein refers to Patients in health care institutions, the embodiments of the present invention may be used for any situation where individuals consume resources and where the cost of certain consumed resources is desired to be known.

“Caregiver(s)” may refer to personnel who provide clinical and other types of care to Patients, and may include but is not necessarily limited to nurses, nurse aids, technicians, unit secretaries, or other personnel that may be associated with the care of a Patient.

“Caregiver Costs” may refer to the costs of Caregivers to care for a Patient or Group of Patients over some specified period of time.

“Skill” of Caregivers may refer to their level of training, experience, licensure, or similar criteria or characteristic.

“Location” may refer to any physical location, cost center, department or area in the institution or health care facility where Caregiver care is given to the Patient, such as the emergency room (ER), the operating room, an intensive care unit (ICU), a nursing unit or floor, an outpatient radiology center, a physical therapy department, or other locations.

“Patient Group” or “Group of Patients” may refer to any group of Patients who have been grouped because of interest in the care costs of the Group. Examples may include all Patients discharged between certain dates, all Patients of a particular hospital service (like Orthopedics), or groups of diagnosis (for example the present Diagnostic Related Groups, International Classification of Diseases or updates to these groupings), or similar groupings.

“Time Interval” may refer to period of time over which Care Costs are to be determined. For example, for a particular Patient, it may be a period defined by a start time and date and an end time and date. Or it may include his entire stay. For a Patient Group, it may be all Patients in this Group that were discharged between date x and date y, or were admitted between dates and discharged between other dates or similar time interval. The Time Interval may include a phase, groups of phases, or parts of phases or be divided into one or more phases (see definition of “Phase” below).

“Caregiver Assignment” may refer to certain Caregiver(s) being assigned to a Patient or Patient Group over some period of time at a Location.

“Caregiver Assignment History” refers to the complete history of Caregiver Assignments for a Patient throughout his stay, including contiguous start and stop times for each Assignment, and the specific Caregiver(s) assigned during each segment.

“Patient Acuity” (or simply “Acuity”) may refer to the level of a Patient's condition in terms of his meeting certain clinical, physical, mental or other outcome progress levels or goals. It may also refer to what Caregiver interventions are necessary to care for the Patient, or a combination of interventions, assessments, and outcomes progress.

An “Acuity Methodology” may refer to both how the Acuity for each Patient is determined, as well as the tools for converting the Acuity measure for a Patient into how much Caregiver time (by Skill) is needed to care for the patient on a Location during some period of time. An example of an acuity methodology is described in U.S. patent application Ser. No. 11/688,454, entitled “Method and System to Determine Patient Acuity, Caregiver Intensity, Staffing Needs, and Caregiver Attributes from Patient Outcomes and Patient Events.”

“Patient Acuity History” may refer to the complete history of a Patient's Acuity from admission to discharge. For each time period of the Patient's stay (e.g. each hour, each shift, from a set of start and end times that are contiguous) this would include what Location the Patient was on and his Acuity level during that time period based on the Acuity Methodology.

“Patient Events” (or simply “Events”) may refer to Events that occur to the Patient or because of the Patient that may require additional Caregiver time above the time required based on the Patient's Acuity. For example, a Patient's discharge may take an hour of Registered Nurse (RN) time independent of the Patient's Acuity. Another example is an RN accompanying a Patient off the Location for a test or procedure; where the Patient may require only ⅕ of a nurse's time on Location because of his Acuity, whereas off the Location, he is consuming the RN's full time.

“Patient Events History” may refer to the complete history of all Events associated with a Patient's stay, including when the Event occurred, how long it occurred, on what Location it occurred, and may also include the Caregiver workload associated with the Event.

“Phases” may be a division of the Time Interval into smaller intervals of time associated with a Patient needing or receiving a different level of care from Caregivers. Each time a Patient changes Location (e.g. moves from the ER to the ICU) may define the beginning of a new Phase, as well as each change of Acuity for the Patient. In addition, each Event that creates a different amount or Skill of Caregiver defines a new Phase. For example, if the Time Interval is the Patient's complete stay, the first Phase may be the Event “admission” to the medical unit, and may be for one hour. If the patient is at Acuity level x for three hours after the end of the first Phase, then that would be the second Phase. If the patient then changes to Acuity level y for nine hours, that nine hours would be the third Phase, etc.

“Staffing System”, “Staff Scheduling System”, “Demand Management System”, or “Staff Management System”, or the like may refer to a system that combines information about the availability of Caregivers with Patients' needs for Caregivers, and supports decision making and reporting concerning matching available Caregivers to needed staffing. Such systems may be electronic or manual.

“Standard Staffing” for a Phase may refer to the number and Skill of Caregivers determined by the hospital or other institution to be the normal, average, benchmark, or otherwise standard amount of staffing required by a certain type of Patient during the Phase. This may form the basis for Standard Care Costs and Total Standard Care Costs.

“Actual Staffing” for a Phase may refer to the number and Skill of Caregivers that were actually used by the Patient or Group of patients for his/her care during the Phase. This may form the basis for Actual Care Costs and Total Actual Care Costs.

“Target Staffing” or “Needed Staffing” for a Phase may refer to the number and Skill of Caregivers indicated by one or more Patients based on their individual Acuity and Events during the Phase. This may form the basis for Target Care Costs and Total Target Care Costs.

“Target Staffing History” for a Patient may refer to the Phase by Phase Target Staffing required by this Patient from admission to discharge.

“Staffing Ratios” may refer to level of a Patient's Caregiver needs defined using a Caregiver to Patient ratio. For example, a Caregiver/Patient ratio of 1:1 refers to one Caregiver per Patient, whereas a ratio of 1:4 means the Patient needs ¼ of a Caregiver.

“Care Costs” for a Phase may refer to the cost of all Caregivers who are in the process of caring for a Patient or Group of Patients during the Phase. Care Costs for a specified Time Interval may be the sum of Care Costs for all Phases in the Time Interval.

“Standard Care Costs” may refer to a predetermined standard Care Costs for a Patient or Group of Patients over some period of time.

“Target Care Costs” for a Phase may refer to Care Costs arising from a measure of what the Patient should receive in terms of care, based on his location, Events, and Acuity during the Phase.

“Actual Care Costs” for a Phase may refer to the actual Care Costs the Patient consumed during the Phase.

“Reimbursed Care Costs” may refer to the Care Costs that the institution will be reimbursed for a Patient or Group of Patients by a third party payer. Note: Reimbursed costs for Caregivers are not presently separated from “room and board” costs for reimbursement, but will likely be available in the near future as a separate cost.

“Overhead Care Costs” may refer to those costs that are in addition to the direct or near-direct costs of caring for Patients. These costs may include costs of all personnel who manage Caregivers, but are not included in the Acuity Methodology of the institution, such as caregiver administration, training, education, recruiting, etc.

“Total Care Costs” may refer to the combination of the Actual, Standard, Reimbursed, or Target Care Costs plus Overhead Care Costs. Thus there may be “Total Standard Care Costs”, “Total Target Care Costs”, “Total Reimbursed Care Costs” and “Total Actual Care Costs”.

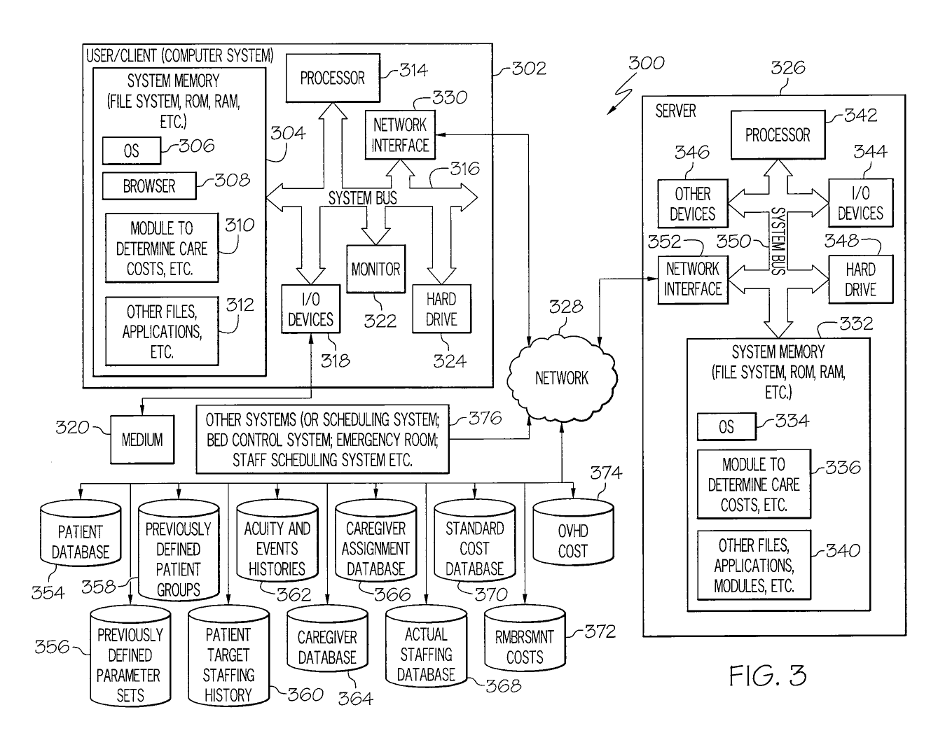

As will be appreciated by one of Skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium, such as for example medium 320 in FIG. 3, having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. In the context of this document, a computer-usable or computer-readable medium may be any tangible medium that can contain or store the program for use by or in connection with the instruction execution system, apparatus, or device.

Computer program code for carrying out operations of the present invention may be written in an object oriented programming language such as Java, Net, Smalltalk, C++, C sharp or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

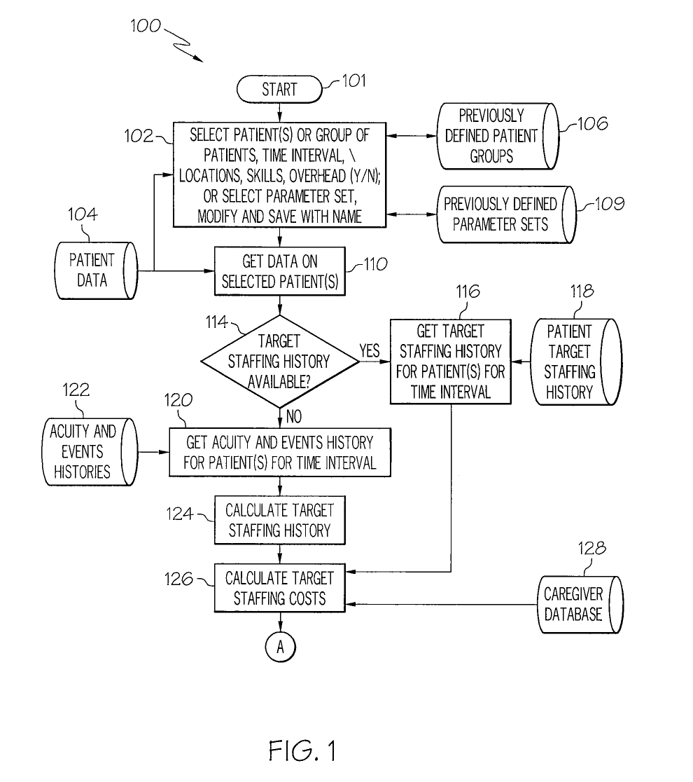

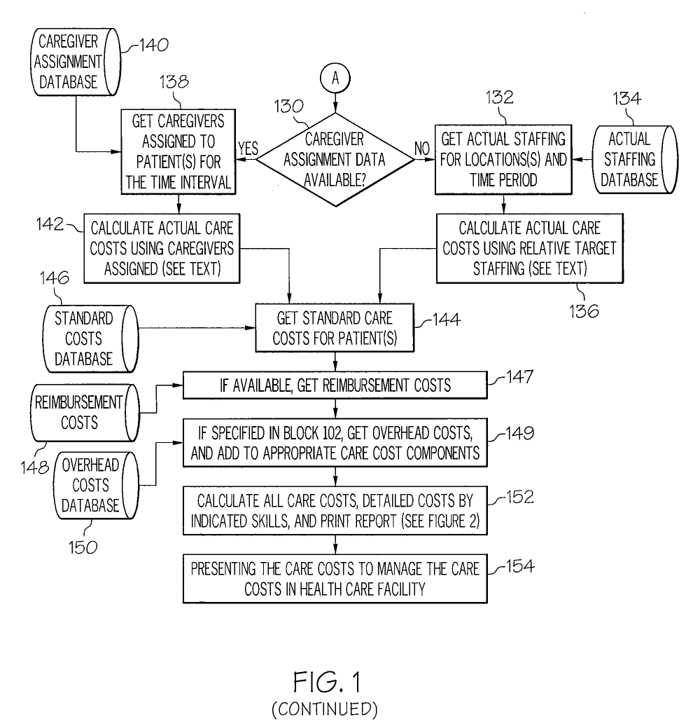

FIG. 1 is a flow chart of an example of a method 100 to determine all Care Costs defined above and to produce reports and comparisons of the Care Costs in accordance with an embodiment of the present invention.

In block 101, the process may start, and may be invoked by the user any time the user wants to capture, calculate, and report on Care Costs.

In block 102, the user may be prompted to identify a Patient, or a Group of Patients, a Time Interval, Locations, Caregiver Skills, and whether to include Overhead Costs in determining Care Costs. The user may be presented with a list of Patients from which to choose, can search for a Patient by name, discharge date, or medical record number. Block 102 may access Patient data from a database of Patient data 104 for these data (name, discharge date, etc.). The user may choose a Group of Patients defined by a predetermined list of Group parameters, or by building a new Group based on parameters such as diagnosis, Diagnostic Related Groups, service, Location(s), or other characteristics. Instead of specifying Patient Group parameters from scratch, the user may obtain a predefined set of Patient Group parameters from database 106. The Patient Group parameters may be used without modification, or may be modified and saved as a new group of Patient Group parameters with a new descriptive label in database 106 for future use.

In block or module 102, instead of specifying parameters from scratch, the user may choose a predetermined set of all parameters (Patient(s), Patient Group, Time Interval, Location(s), Skill(s), and include Overhead Costs or not) from such parameter sets stored in database 109. Such parameters sets may be retrieved by the user from database 109 and used as is, or the parameters may be modified and saved as new a set of parameters with a new descriptive label in database 109 for future use. If parameters were developed from scratch (above), this set of parameters may also be labeled with an appropriate descriptive label and saved in database 109.

In block or module 110, data for Patient(s) selected and Time Interval selected may be obtained from a database of Patient data 104 For all patients selected, such data may include diagnosis, admit and discharge dates and times, Locations where the Patient(s) were with dates and times, and other data needed for the analysis below.

In block 114, an assessment may be made if Target Staffing History exists for the Patient(s) during the Time Interval. If yes, then in block 116 such Target Staffing History may be obtained from database 118, and the method 100 may move to block 126. If there is no Target Staffing History, the method 100 may move to block 120.

In block 120, Acuity History and Event History for the Patient(s) for each Phase of the specified Time Interval may be obtained from the Acuity and Events History database 122. If the Acuity Methodology used by the institution does not include Events, then only Acuity History will be obtained here. An example of determining patient acuity or an acuity methodology is described in U.S. patent application Ser. No. 11/688,454, filed Mar. 20, 2007, entitled “Method and System to Determine Patient Acuity, Caregiver Intensity, Staffing Needs, and Caregiver Attributes from Patient Outcomes and Patient Events,” which is assigned to the same assignee as the present invention and is incorporated herein in its entirety by reference.

In block 124, Target Staffing History for the Patient(s) for each Phase of the specified Time Interval is calculated using the Acuity Methodology's tools for converting Acuity levels into Target Staffing. This may require a calculation that looks at both the location of the Patient(s), and the time of day or shift for which Target Staffing is to be generated, depending on the Acuity Methodology used by the institution. The result, for each Patient in the analysis, is the number of hours of each Caregiver Skill needed for each Phase of the Time Interval. For example, if the institution's Acuity Methodology calculated Target staffing for each 8-hour shift of each Patient's stay, then for each 8-hour Phase (or portion thereof) in the Time Interval, the number of hours of each Skill of Caregiver needed (Target staffing) is calculated using the institution's Acuity Methodology for converting Acuity into Target staffing.

In block 126, Target Care Costs for each Phase in the Time Interval is calculated by using the Target Staffing History determined in block 124 or block 116, and data from a Caregiver database 128 which includes the hourly costs of each Caregiver, as well as average costs per hour by Caregiver Skill and by Location. When multiplied by the Target hours required by Skill, Target Care Costs may be calculated for the selected Patient(s) and Time Interval.

Thus, for each Patient in the analysis, the Target Care Costs for the patient during the Time Interval may be determined according to equation 1:

Target Care Cost=Σ_{p=1,P}Σ_{S=1,S}CCₛ₁Hₛ₁ₚ Eq. 1

### Where

S is the index of the S Caregiver Skills;
P is the index of the P Phases in the Time Interval;
L is the index of the Location where the Patient is during Phase p;
CCₛ₁ is the average cost per hour for a Caregiver of Skill s on Location I;
Hₛ₁ₚ is the number of hours needed by the Patient of Skill s Caregiver on Location I in Phase p.

In block 130, an assessment may be made whether Caregiver Assignment data is available for the Patient(s) during the selected Time Interval. If no, the method 100 may proceed to block 132. If yes, the method 100 may proceed to block 138.

In block 132, actual staffing for all Locations where the Patient(s) was during each Phase of the specified Time Interval is gathered from an actual staffing database 134. The actual staffing database 134 may be maintained by any Staff Management or Demand Management system such as those found in most hospitals today. Examples of Staff Management or Demand Management systems may include ANSOS available from the McKesson Corporation, San Francisco, Calif.; ClairVia available from AtStaff, Inc., Durham, N.C.; KRONOS provided by KRONOS Incorporated, Chelmsford, Mass.; and API LaborWorks available from API Software, Inc., Harford, Wis.

In block 136, Actual Care Costs for the Patient(s) during the Time Interval is calculated. First, actual care costs for the entire Location where the Patient(s) was during each Phase of the Time Interval selected is calculated, by Skill of Caregiver. Then a Patient's Actual Care Costs can be estimated by using the proportion of the Patient's Target need for Caregiver time (based on his Acuity and Events) to the total Target need across all Patients on the Location during this Phase of the Time Interval. For example, if the Patient in question needed (from Acuity and Events) a Target of 4 hours of RN care during this Phase, and the total Target hours of RN care needed by all Patients on the Location during this Phase is 80 hours, then this Patient would be allocated 5% of the total costs of RNs on this Location during this Phase. Total actual care costs may be allocated among the group of patients using relative target staffing indicated by the relative acuity of the group of patients. This calculation is made for all Phases within the Time Interval, and for all Skills identified in Block 102. If the analysis is for a Group of Patients, these calculations may be made for all Patients in the Group.

In block 138, where Caregiver Assignment data is available, Caregivers assigned to this Patient(s) and all other Patients during each Phase of the selected Time Interval is obtained from the assignment database 140.

In block 142, a particular Patient's Actual Care Costs from an assigned Caregiver may then be the proportion of Target staffing needed by this Patient to the total Target time needed by all Patients assigned to this Caregiver, times the cost of this Caregiver. For example, if the Phase is eight hours, and the Patient in question needed (Target, based on Acuity and Events) two hours of care, and all other Patients assigned to this Caregiver needed (Target) ten hours of care, then there were twelve hours of care needed (Target) from the eight hours of Caregiver time actually consumed. The Patient in question would be “charged” 2/12 or ⅙ of the eight hours of care, or 8/6 or 1 hour and 20 minutes. Using the hourly cost of this particular Caregiver, the Patient would be “charged” 1 and ⅓ hours at the cost of that Caregiver.

In block 144, Standard Care Costs for the Patient(s) for the selected Time Interval may be obtained from a database 146 of Standard Care Costs. The “standard” is whatever the institution considers standard; for example the average cost per hour of RN time (over all RNs) times the number of RN hours needed (from Acuity and Event data) for the Patient(s) over the selected time frame. Another example of “Standard” may be the budgeted costs by Caregiver Skill. Standard care costs may be allocated among the group of patients using the relative target staffing indicated by the relative acuity of the patients similar to that previously described with respect to actual care costs.

In block 147, if Reimbursed Care Costs are available, then these costs may be retrieved from a database of Reimbursed Care Costs in block 148.

In block 149, if the parameter or option to include Overhead Care Cost was previously selected in block 102, Overhead Care Costs may be obtained from database 150. This may be a standard Overhead Care Cost calculated at an hourly rate such as the total Overhead Care Costs for the year divided by the total number of Caregiver hours consumed. Also in Block 149 (if the Overhead Care Cost option or parameter was selected in block 102) the calculated Overhead Care Costs may be added to the Standard, Target, and Actual Care Costs to get Total Care Costs in those three categories.

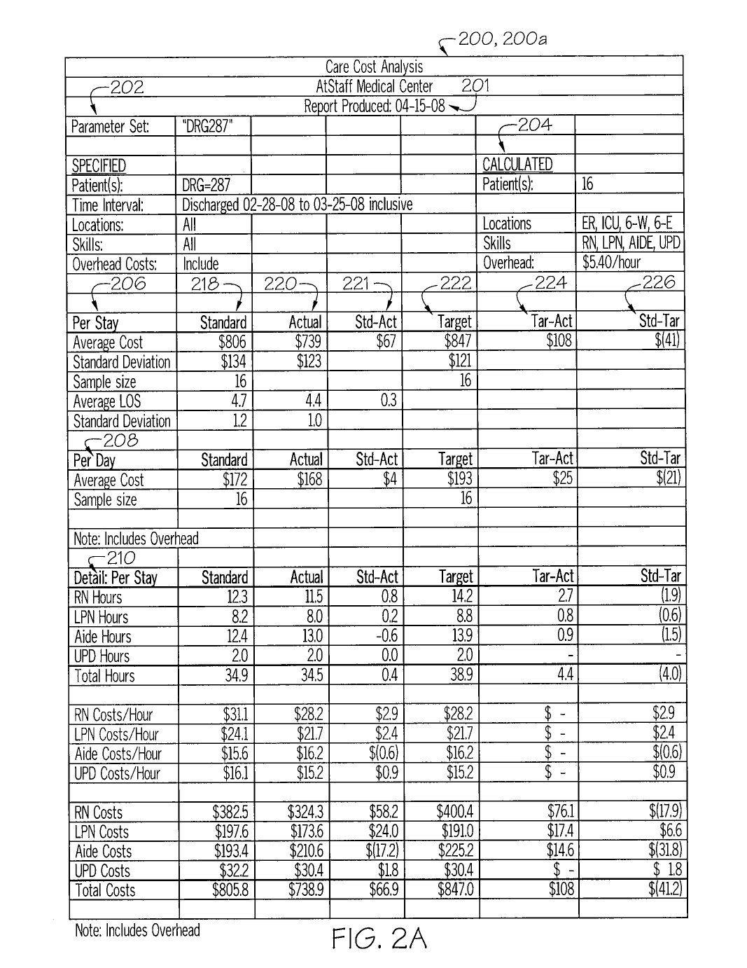

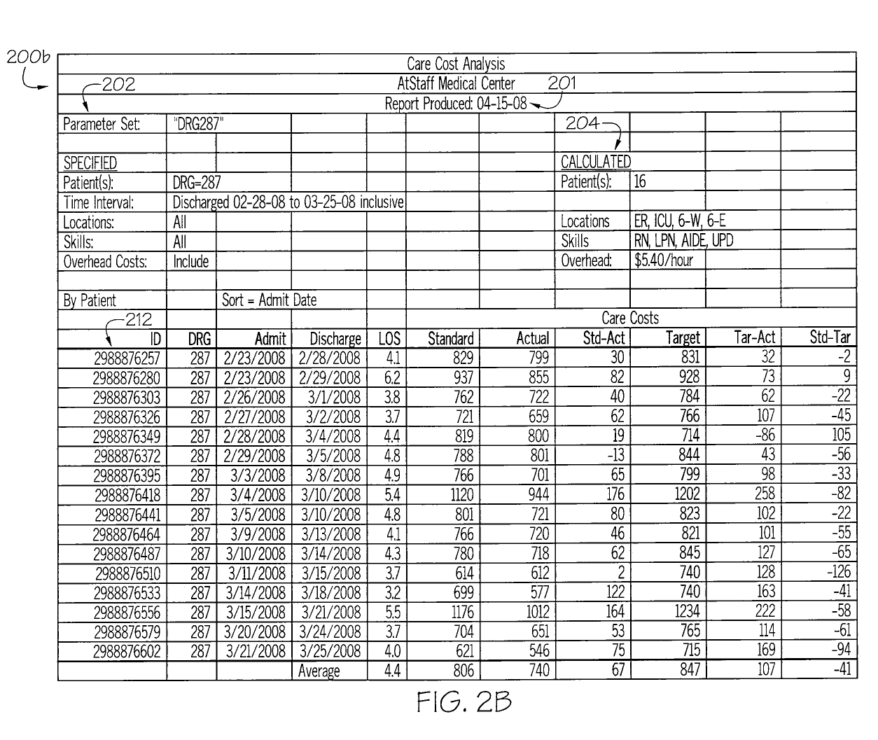

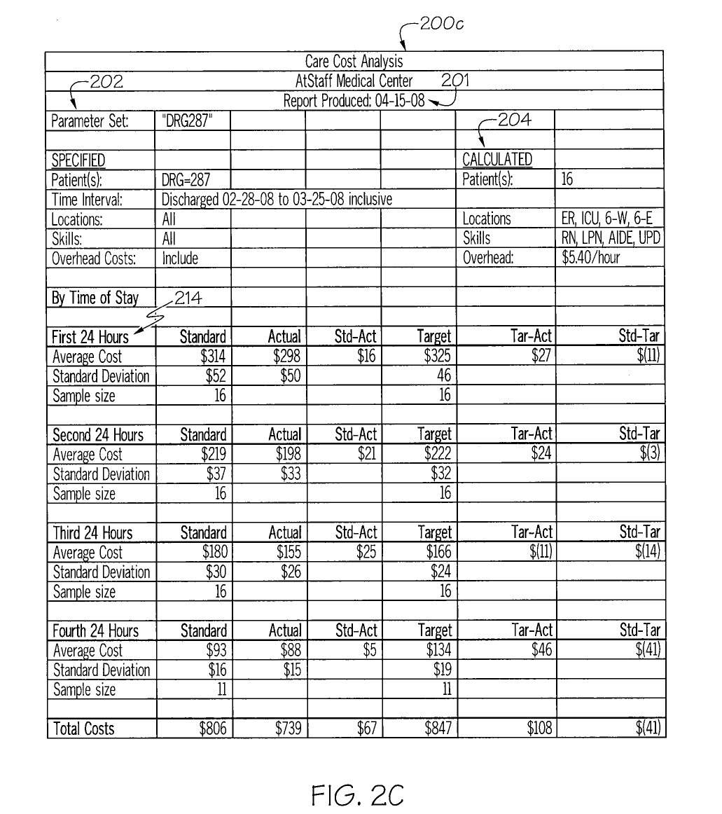

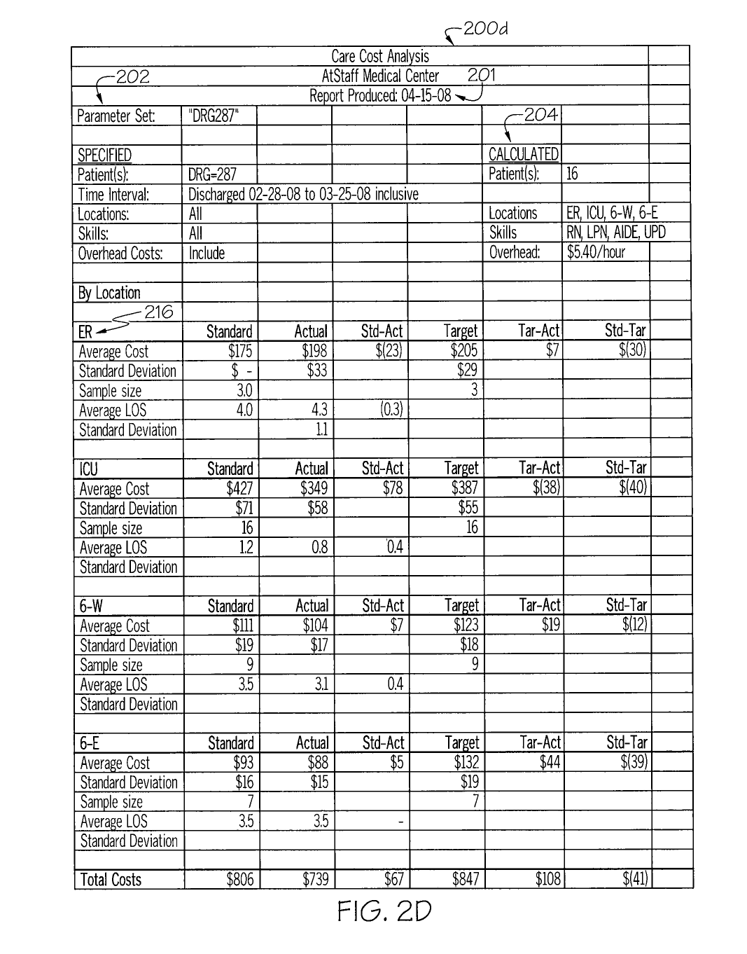

In block 152, all Care Costs may be calculated. Detailed Care Costs by indicated Caregiver Skill, Time Interval, and location may be determined. FIGS. 2A-2D demonstrate how Standard, Actual, Target and Overhead Care Costs (obtained in blocks 144, 142 or 136, 126, and 149, respectively) may be compared to manage care costs. If Reimbursement Care Costs are available from Block 144, they too may be included in the analysis of FIG. 2A-2D.

In block 154, reports may be generated showing the four categories of Care Costs for the Patient(s) over the selected Time Interval, with comparisons and variances calculated. Also reportable are certain detail amounts of care and Care Costs (for example by Caregiver Skill) used during the compilation of Care Costs. FIGS. 2A-2D are collectively an example of the type of report that may be generated. The resulting Care Costs may also be electronically sent to other costing systems in the institution, and/or exported to spreadsheets or other report-generating software for customized reporting. Each of the different Care Costs reports or report portions are described in more detail herein. The Care Cost reports may be used to manage care costs in a health care facility or other institution.

The captured Acuity and Events histories in database 122, actual staffing data in database 134, Caregiver Assignment data in database 140, and any other data as described above may include real-time or near real-time data from electronic care documentation systems that may be maintained by an interdisciplinary care team or the like. A health industry information exchange standard known as Health Level Seven (HL7) may be used; however, future information exchange standards may also provide the real-time or near real-time data.

Alternatively, or in addition to Patient Acuity, Events, staffing, Assignment, and other data as needed from electronic documentation systems, the captured data may include direct entry of pertinent data that is maintained in physical, paper or hard copy records, or a summarization of such records.

FIGS. 2A-2D are collectively an example of a Care Cost Report 200 that may be generated from the process in FIG. 1 in accordance with an embodiment of the present invention. The Care Cost Report 200 may be prepared and printed, such as a spreadsheet, or sent to another system for further analysis. Each of FIGS. 2A-2D illustrates a different portion 200a-200d of the Cost Report 200 or type of Cost Care Report. For example, FIG. 2A is an example of a summary of all Care Costs. FIG. 2B is an example of Care Costs by patient. FIG. 2C is an example of Care Costs by day, and FIG. 2D is an example of Care Costs by unit. Each Care Cost report may include a field 201 for the date the report was produced.

A set of report parameters 202 that may correspond to the parameters selected by the user in block 102 of FIG. 1 may be shown in a first column of each Care Cost Report portion 200a-200d. Examples of the parameter set that may be specified may include Patient(s), Time Interval, Location(s), Average Length of Stay (LOS), Skills, and may also include whether Care Cost Overhead is to be added, and what Overhead Costs are.

Section 204 may include information calculated during the running of the analysis or method 100. For example, if “All” Locations are specified in the parameter set 202, those Locations where Patient(s) in the analysis were actually located would be listed in Section 204.

Section 206 may include Care Costs details for the Time Interval for the Patient(s) defined in the report parameters selected for the analysis. This may be for the complete stay (from admission to discharge) of the Patient(s), in which case this section would be labeled “Per Stay” as in the example illustrated in FIG. 2A. If the Time Interval specified was for a period shorter than the Patient(s) complete stay, Section 206 would be for that Time Interval and would be labeled “Per Time Interval”. If for complete stays, the Average Length of Stay (LOS) is calculated and displayed

The Care Cost Report 200 may include columns for Standard Care Costs (“Standard”) 218, Actual Care Costs (“Actual”) 220, a comparison of Standard Care Costs and Actual Care Cost (“Std-Act”) 221 which may be Standard Care Costs less Actual Care Costs. The Care Cost Report 200 may also include Target Care Costs (“Target”) 222, a comparison of Target Care Costs and Actual Care Costs (“Tar-Act”) 224 which may be Target Care Cost less Actual Care Cost, and a comparison of Standard Care Cost and Target Care Cost (“Std-Tar”) 226 which may be the Standard Care Cost less the Target Care Cost. If Reimbursed Costs are available, this report may also include these costs and a comparison of Reimbursed Costs to the other costs. These different care costs have been defined in more detail above.

Section 208 may include Per Day Care Costs, when the Time Interval covers multiple days, and/or when it includes all Patients discharged during the Time Interval. As in the Per Stay section (206), Standard, Actual, and Target Care Costs may be listed and compared, this time on a per day basis rather than the whole stay.

Section 210 may include a breakdown of Care Costs by Skill, and again would be Per Stay (as in this example) or Per Time Interval depending on whether the Time Interval includes the Patient's(s') entire stay or not.

Section 212 (FIG. 2B) may include a list of all patients in the analysis, with their individual Care Cost calculations.

Section 214 (FIG. 2C) may include an analysis of the Care Cost associated with different sequential time intervals for the patients, such as (as illustrated) the first 24 hours of stay, the second 24 hours of stay, etc.

Section 216 (FIG. 2D) may include an analysis of Care Costs by Location.

FIG. 3 is a block diagram of an example of a system 300 to continuously determine Care Costs in accordance with an embodiment of the present invention. The method 100 of FIG. 1 may be embodied in and performed by the system 300. The Care Cost Report 200 of FIGS. 2A-2D may be generated and presented by the system 300. The system 300 may include one or more user or client computer systems 302 or similar systems or devices.

The client computer system 302 may include a system memory or local file system 304. The system memory 304 may include a read only memory (ROM) and a random access memory (RAM). The ROM may include a basic input/output system (BIOS). The BIOS may contain basic routines that help to transfer information between elements or components of the computer system 302. The RAM or system memory 304 may contain an operating system 306 to control overall operation of the computer system 302. The RAM may also include a browser 308 or web browser to access remote applications or the like such as a system and method to determine Patient Acuity, staffing needs, care giver attributes and related data that may reside on a remote server or system. The browser 308 may also facilitate presentation of any user interfaces associated with embodiments of the present invention. The RAM may also include a module or modules 310 or computer-executable code to determine Care Costs, such as that described with respect to method 100 of FIG. 1. Some or all of the elements of this method may reside on a remote server or system 326. The RAM may further include other application programs 312, other program modules, data, files and the like for other purposes or functions.

The computer system 302 may also include a processor 314 to control operations of the other components of the computer system 302. The operating system 306, browser 308, module or modules 310 and other program modules 312 may be operable on the processor 314. The processor 314 may be coupled to the memory system 304 and other components of the computer system 302 by a system bus 316.

The computer system 302 may also include multiple input devices, output devices or combination input/output devices 318. Each input/output device 318 may be coupled to the system bus 316 by an input/output interface (not shown in FIG. 3). The input and output devices or combination I/O devices 318 permit a user to operate and interface with the computer system 302 and to control operation of the browser 308 and program module or modules 310 to access, operate and control the system and method to determine and analyze care costs. The I/O devices 318 may include a keyboard and computer pointing device or the like to perform the operations discussed herein.

The I/O devices 318 may also include disk drives, optical, mechanical, magnetic, or infrared input/output devices, modems or the like. The I/O devices 318 may be used to access a medium 320. The medium 320 may contain, store, communicate or transport computer-readable or computer-executable instructions or other information for use by or in connection with the system 302.

The computer system 302 may also include or may be connected to other devices, such as a display or monitor 322. The monitor 322 may be used to permit the user to interface with the computer system 302. The monitor 322 may present the images, web pages, user interfaces or screen shots to a user or staffing decision maker that may be generated by the module 310 to determine Care Costs.

The computer system 302 may also include a hard disk drive 324. The hard drive 324 may be coupled to the system bus 316 by a hard drive interface (not shown in FIG. 3). The hard drive 324 may also form part of the local file system or system memory 304. Programs, software and data may be transferred and exchanged between the system memory 304 and the hard drive 324 for operation of the computer system 302.

The computer systems 302 may communicate with a remote server 326 or system and may access other servers or other computer systems (not shown) similar to computer system 302 via a network 328. The system bus 316 may be coupled to the network 328 by a network interface 330. The network interface 330 may be a modem, Ethernet card, router, gateway or the like for coupling to the network 328. The coupling may be a wired connection or wireless. The network 328 may be the Internet, private network, an intranet or the like.

The server 326 may also include a system memory 332 that include a file system, ROM, RAM and the like. The system memory 332 may include an operating system 334 similar to operating system 306 in computer systems 302. The system memory 332 may also include a module or modules 336 to determine Care Costs. The module or modules 336 may include operations similar to those described with respect to method 100. As previously discussed, all or portions of the operations associated with this method may be performed by the server 326 and/or the computer systems 302. The computer systems 302 may access the server 326 and the module 336 via the browser 308 and network 328 to determine care costs and analyze care costs similar that previously discussed. The server system memory 332 may also include other files 340, applications, modules and the like for other purposes or to perform other operations.

The server 326 may also include a processor 342 or a processing location to control operation of other devices associated with the server 326. The server 326 may also include I/O device 344. The I/O devices 344 may be similar to I/O devices 318 of computer systems 302. The server 326 may further include other devices 346, such as a monitor or the like, to provide an interface along with the I/O devices 344 to the server 326. The server 326 may also include a hard disk drive 348. A system bus 350 may connect the different components of the server 326. A network interface 352 may couple the server 326 to the network 328 via the system bus 350.

The computer systems 302 and/or server 326 may also access different databases and tables as described with respect to the method 100. For example the system 300 may include a patient database 354 to include data related to current and past patients; previously defined parameter sets database 356 similar to parameter sets 202 described with reference to FIGS. 2A-2D; previously defined patient groups 358 similar to that previously described; a patient target staffing history database 364 to provide historical target staffing needs of patients or groups of patients; an acuity and events history database 362; a caregiver database 364; a caregiver assignment database 366; an actual staffing database 368; a standard cost database 370; a reimbursement costs database 372; and an overhead cost database 374.

The client computer system 302 and/or the server 326 may also access other systems 376 within an institution or organization, such as an electronic care documentation system, direct entry clinical care system, or other system, to determine Care Costs similar to that described herein.

While the present invention has been described with respect to determining Care Costs that may be associated with the health care industry, the principles and features of the present invention may be applicable to any industry or operation that involves staffing personnel and insuring that critical operations or functions are staffed by personnel with the appropriate Skill sets.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or Groups thereof.

Although specific embodiments have been illustrated and described herein, those of ordinary Skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein. Additionally, while the present invention has been described with respect to application to health care, the present invention may be adapted for scheduling personnel in other fields or industries.

What is claimed is:

1. A method to manage caregiver costs in a health care facility, comprising:
allowing selection of a patient or group of patients for analyzing care costs;
allowing selection of a set of parameters related to services provided to the patient or group of patients by the health care facility;
collecting patient data associated with the selected patient or group of patients based on the set of parameters;
determining at least one of patient acuity, location within the health care facility and caregiver attributes for the selected patient or group of patients based on the patient data;
determining care costs based on at least one of the patient acuity, location, and caregiver attributes for the patient or group of patients; and
presenting a care costs report to a user to manage care costs within the health care facility.

2. The method of claim 1, wherein allowing a selection of a set of parameters comprises allowing selection of a time interval over which care costs are to be analyzed;
allowing selection of the location within the health care facility for which care costs are to be analyzed; and
allowing selection of a skill of caregiver for which care costs are to be analyzed.

3. The method of claim 2, wherein allowing selection of a set of parameters further comprises allowing selection of whether overhead costs are to be included in analysis of the care cost.

4. The method of claim 1, further comprising:
acquiring a target staffing history for the selected patient or group of patients for a selected time interval in response to the target staffing history being available;
acquiring an acuity and events history for the selected patient or group of patients for the selected time interval in response to the target staffing history not being available;
calculating the target staffing history for the selected patient or group of patients for the selected time interval from the acuity and events history in response to the target staffing history not being available; and
calculating target staffing cost from the calculated or available target staffing history.

5. The method of claim 1, further comprising calculating an actual staffing cost for the patient or group of patients for a selected time interval.

6. The method of claim 5, further comprising:
acquiring caregivers assigned to the patient or group of patients for the selected time interval in response to caregiver assignment data being available; and
calculating the actual staffing cost using the caregiver assignment data.

7. The method of claim 5, further comprising:
acquiring the actual staffing for the location during the selected time interval in response to caregiver assignment data not being available;
determining a target staffing need for all patients at the location;
determining a target staffing need for the selected patient or group of patients at the location; and
calculating staffing cost for the selected patient or group of patients at the location as a proportion of the target staffing need for the selected patient or group of patients to the target staffing need for all patients at the location.

8. The method of claim 1, further comprising determining the care costs for the patient or group of patients for at least one of one of a selected time interval, discharged between selected dates, from admission to a present time, from admission to discharge.

9. The method of claim 1, further comprising allocating total actual care costs among the group of patients using relative staffing indicated by relative acuity of the group of patients.

10. The method of claim 1, further comprising allocating standard care costs among the group of patients using the relative target staffing indicated by the relative acuity of the patients.

11. The method of claim 1, further comprising allocating actual care costs among patients using both relative target staffing indicated by a relative acuity of the group of patients and caregiver assignment for the group of patients.

12. A system to manage caregiver costs in a health care facility, comprising:
a processor;
a module operable on the processor to determine care costs, wherein the module is adapted to allow selection of a set of parameters related to services provided to the patient or group of patients by the health care facility, to collect patient data associated with the selected patient or group of patients based on the set of parameters, to determine at least one of patient acuity, location within the health care facility and caregiver attributes for the selected patient or group of patients based on the patient data, and to determine care costs based on at least one of the patient acuity, location, and caregiver attributes for the patient or group of patients.

13. The system of claim 12, further comprising an output device to present a care costs report to a user to manage costs within the health care facility.

14. The system of claim 12, further comprising:
a patient database to store data related to a patients stay in the health care facility;
a patient target staffing history database to store data related to a number and skill of caregivers based on a patient's acuity and events;
a caregiver assignment database to store data related to caregiver assignments for a patient during the patients stay including contiguous start and stop times for each assignment.

15. The system of claim 12, further comprising:
an actual staffing database to store actual care costs for a phase for each patient;
a standard cost database to store predetermined standard care costs for a patient or group of patients over a predetermined time interval.

16. A computer program product to manage caregiver costs in a health care facility, the computer program product comprising:
a computer usable medium having computer usable program code embodied therein, the computer usable medium comprising:
computer usable program code configured to allow selection of a patient or group of patients for analyzing care costs;
computer usable program code configured to allow selection of a set of parameters related to services provided to the patient or group of patients by the health care facility;
computer usable program code configured to collect patient data associated with the selected patient or group of patients based on the set of parameters;
computer usable program code configured to determine at least one of patient acuity, location within the health care facility and caregiver attributes for the selected patient or group of patients based on the patient data;
computer usable program code configured to determine care costs based on at least one of the patient acuity, location, and caregiver attributes for the patient or group of patients; and
computer usable program code configured to present a care costs report to a user to manage costs within the health care facility.

17. The computer program product of claim 16, wherein the computer usable medium further comprises:
computer usable program code configured to allow selection of a time interval over which care costs are to be analyzed;
computer usable program code configured to allow selection of the location within the health care facility for which care costs are to be analyzed; and
computer usable program code configured to allow selection of a skill of caregiver for which care costs are to be analyzed.

18. The computer program product of claim 16, wherein the computer usable medium further comprises:
computer usable program code configured to acquire a target staffing history for the selected patient or group of patients for a selected time interval in response to the target staffing history being available;
computer usable program code configured to acquire an acuity and events history for the selected patient or group of patients for the selected time interval in response to the target staffing history not being available;
computer usable program code configured to calculate the target staffing history for the selected patient or group of patients for the selected time interval from the acuity and events history in response to the target staffing history not being available; and
computer usable program code configured to calculate target staffing cost from the calculated or available target staffing history.

19. The computer program product of claim 16, wherein the computer usable medium further comprises computer usable program code configured to calculate an actual staffing cost for the patient or group of patients for a selected time interval.

20. The computer program product of claim 16, wherein the computer usable medium further comprises:
computer usable program code configured to acquire the actual staffing for the location during the selected time interval in response to caregiver assignment data not being available;
computer usable program code configured to determine a target staffing need for all patients at the location;
computer usable program code configured to determine a target staffing need for the selected patient or group of patients at the location; and
computer usable program code configured to calculate staffing cost for the selected patient or group of patients at the location as a proportion of the target staffing need for the selected patient or group of patients to the target staffing need for all patients at the location.
